(19) United States
(12) Patent Application Publication
(10) Pub. No.: US 2006/0122822 A1
(43) Pub. Date: Jun. 8, 2006

(54) Language grammar driven recognizer of similar code fragments and methods

(76) Inventors: Alexander Simon, St. Petersburg (RU); Nikolay Tarnakin, St. Petersburg (RU); Dmitry Barmenkov, St. Petersburg (RU); Michael Ershov, St. Petersburg (RU)

Correspondence Address: MACCORD MASON PLLC, 300 N. GREENE STREET, SUITE 1600, P. O. BOX 2974, GREENSBORO, NC, 27402, US

(21) Appl. No.: 11/003,124

(22) Filed: Dec. 3, 2004

(51) Int. Cl. G06F 17/27

(52) U.S. Cl. 704/9

(57) ABSTRACT

A system and method for a language grammar driven recognizer for assessing the similarity of identified source code fragments for software development.

### BACKGROUND OF THE INVENTION

(1) Field of the Invention

The present invention relates generally to systems and methods for software code development and editing and, more particularly, to systems and methods for automatic recognition of the same or similar code fragments for auditing source code by a user.

(2) Description of the Prior Art

Prior art software editors are known to employ auditing functions. However, the presence of big code fragments with similar structure usually signals a problem like programming using copying, which can present additional problems with the code development. Instead, this code should be refactored using, for example, the extract superclass, extract method, pull up method/variable, push down method/variable and rename. Unfortunately, it is very difficult to find the same fragments in a large project simply due to the volume of code to review or audit. This task becomes more complicated if the text of the compared fragments is not absolutely identical yet has the same syntax structure, i.e., it only differs in formatting, comments, names of variables and types. Similar code fragments increase application size that is critical for some domains; increase probability of errors; and complicate source code maintenance and modification.

Notably, in the prior art, software development companies and software developers usually solve this problem by manual source code review, which is a very laborious process, in particular for larger projects.

Thus, there remains a need for automated language grammar driven recognition of same or similar code fragments or groups of code to avoid the problems associated with the development of software code and auditing associated with the prior art methods.

### SUMMARY OF THE INVENTION

The present invention is directed to a system and methods for providing language grammar driven recognizer of similar code fragments for software development having a language grammar driven recognizer for assessing the similarity of identified source code fragments, wherein the recognizer determines the similarity of the code fragments based upon similarity strategies.

In the preferred embodiment, audit that analyzes the code structure, finds groups with similar code and visualizes them in the form convenient for the future in-depth analysis. The user of the software having language grammar driven recognizer of similar code fragments for software development can then examine the corresponding summary review and the text of every potential code block. The summary view of the present invention preferably consists of a list of methods and a different list with highlighted differences for the duplicate or similar code fragments.

Accordingly, one aspect of the present invention is to provide a system for providing language grammar driven recognizer of similar code fragments for software development including: a data processing system including a processor and a memory device on which a software program is running; the software program providing a pattern and a user interface; at least one input device and an output device for interfacing with a user; the output device including a display and the at least one input device including at least one indication; and a language grammar driven recognizer for assessing the similarity of identified source code fragments, wherein the recognizer determines the similarity of the code fragments based upon similarity strategies.

Another aspect of the present invention is to provide a method for providing real-time thread simulation for software including the steps of: providing a data processing system including a processor and a memory device on which a software program is running; the software program providing a language grammar driven recognizer for assessing the similarity of identified source code fragments and a user interface viewable by a user on the output device; at least one input device and an output device for interfacing with a user; the output device including a display and the at least one input device including at least one indication made by the user; and language grammar driven recognizer for assessing the similarity of identified source code fragments; the software program operating to automatically assess the similarity of the source code fragments based upon similarity strategies.

These and other aspects of the present invention will become apparent to those skilled in the art after a reading of the following description of the preferred embodiment when considered with the drawings.

### BRIEF DESCRIPTION OF THE DRAWINGS

FIGS. 1-5 are a screen capture views of a graphic user interface constructed according to the present invention.

### DETAILED DESCRIPTION OF THE PREFERRED EMBODIMENTS

Referring now to the figures in general, the illustrations are for the purpose of describing a preferred embodiment of the invention and are not intended to limit the invention thereto. The figures provide examples illustrative of embodiments of the present invention, more specifically screen shots of graphic user interfaces (GUIs) displayed on a computer display to a user for interfacing with the system and methods of the present invention for auditing software.

The present invention provides a language grammar driven recognizer of similar code fragments and methods. More particularly, the system includes a software audit component with source code analysis functionality. In a preferred embodiment of the present invention, a system is provided for providing a language grammar driven recognizer of similar code fragments for use in audits of a source code for software development, the system including a data processing system including a processor and a memory device on which a software program is running; the software program providing a graphic user interface (GUI) viewable by a user; at least one input device and an output device for interfacing with the user; the output device including a display and the at least one input device including at least one indication; and a language grammar driven recognizer of similar code fragments wherein similarity strategies are used for determining whether the identified code fragments or groups are the same, substantially the same, or similar to each other, based on default settings and/or user inputs determining the similarity strategies.

Furthermore, the software is operable to build textual representation of source code using terms grammar productions, including terminal and non-terminal symbols. Then, in methods for editing source code according to the present invention, the software is operable to replace all occurrences of grammar production with predefined symbols, more particularly for identifier, literal, operation and code block. Also, the software is operable to store the original identifiers and literals in special tables, wherein the stored references to the source code include concrete positions for all signatures.

The software is further operable to search signature list for occurrences of similar or near-same structures. A similarity strategy can be specified by a user of the system, wherein at least two arbitrary arithmetical expressions or operations can be considered similar or not. For example: the software is operable to consider two statements a=b+c and a=b−c. Expressions b+c and b−c can be considered to be similar or not depending on the similarity strategy. As result, the above statements will be considered similar or not based upon the similarity strategy provided, either by default according to the software preferences or by input from the user. Thus, the similarity strategy provides whether two arbitrary code blocks can be considered similar regardless of their contents or not.

By way of resolving the problems of prior art, the present invention system and methods provide for an audit that automatically analyzes the code structure, finds groups with the same or similar code and visualizes them in the form convenient for the future in-depth analysis. The user can examine the corresponding summary review and the text of every potential code block. The summary view consists of a list of methods and a diff list with highlighted differences for the duplicate code fragments. Every code fragment can be opened in the editor. In addition, the result table indicates the found group power (amount of fragments) and the size of every fragment (amount of statements). The audit supports any language having the expression-level parsers.

Preferably, an automatic audit operating according to the present invention provides for the following key steps:

Building textual representation of the source code in terms grammar productions including terminal and non-terminal symbols, wherein all occurrences of grammar production for identifier and literal are replaced by predefined symbols. The original identifiers and literals are stored in the special tables as far as the references to the source code, i.e., to concrete positions, are stored for all signatures. Language structures are replaced to codes mapping to their types. The signatures are stored in the special list. Optionally, code block productions, i.e., the sequence of statements and local variable declaration statements within braces, are replaced by one statement, which contains only the name of detected production;

Searching the signature list for the occurrences of the same or near-the-same structures. Various search strategies are possible. Example: the list of signatures is sorted as an ordinary list of strings. Similar signatures are placed one after another. Unique signatures are excluded from the list. The same signatures are combined in the sought groups; and

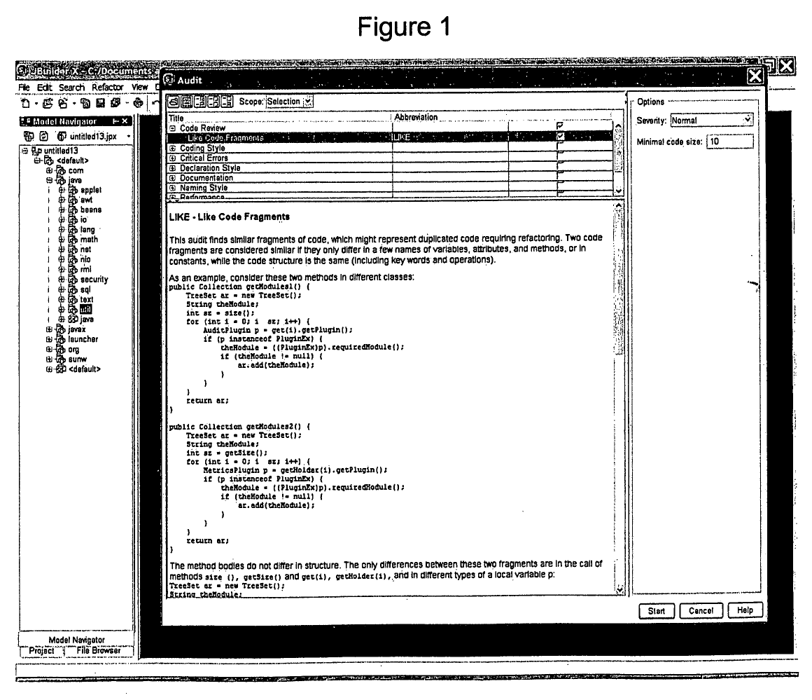

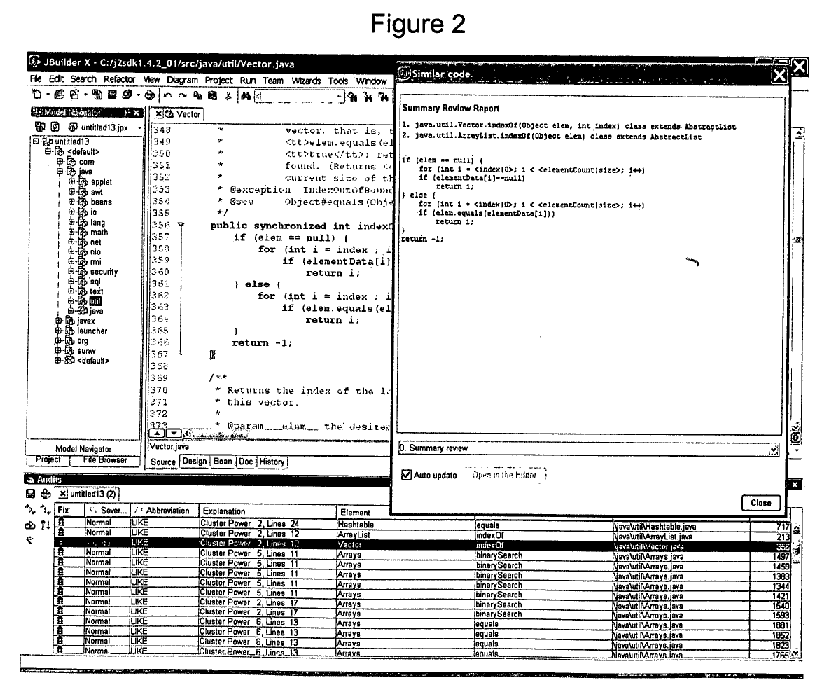

Presenting the results to user using the convenient single-pane view as shown in FIGS. 1 and 2. For summary review, the common code is normalized, i.e., removing comments and formatting. The differences are shown as the list with color highlighting.

By way of example and not limitation, one preferred embodiment of the present invention includes software commercially available from Borland Software Corp., namely Borland Enterprise Studio 7 for Java. Screen capture diagrams are provided as illustrations of the audit in FIGS. 1 and 2.

This section outlines a few design examples, not necessarily optimized, but illustrative of what can be done for systems and methods according to the invention set forth hereinabove. These design examples include the following and further embodied in commercial software provided by Borland Software Corp., namely Borland Enterprise Studio 7 for Java.

This audit automated by software and methods according to the present invention finds same or similar fragments of code, which might represent duplicated code requiring refactoring. Two code fragments are considered similar if they only differ in a few names of variables, attributes, and methods, or in constants, while the code structure is the same (including key words and operations). As an example, consider these two methods in different classes:

public Collection getModules1( ) {

TreeSet ar = new TreeSet( );
String theModule;
int sz = size( );
for (int i = 0; i < sz; i++) {

AuditPlugin p = get(i).getPlugin( );
if (p instanceof PluginEx) {

theModule = ((PluginEx)p).requiredModule( );
if (theModule != null) {

ar.add(theModule);

}

}

}
return ar;

}
public Collection getModules2( ) {

TreeSet ar = new TreeSet( );
String theModule;
int sz = getSize( );
for (int i = 0; i < sz; i++) {

MetricsPlugin p = getHolder(i).getPlugin( );
if (p instanceof PluginEx) {

theModule = ((PluginEx)p).requiredModule( );
if (theModule != null) {

ar.add(theModule);

}

}

}
return ar;

}

The method bodies do not differ in structure. The only differences between these two fragments are in the call of methods size ( ), getSize( ) and get(i), getHolder(i), and in different types of a local variable p:

TreeSet ar = new TreeSet( );
String theModule;
int sz = <size|getSize>( );
for (int i = 0; i < sz; i++) {

<AuditPlugin|MetricsPlugin> p = <get|getHolder>(i).getPlugin( );
if (p instanceof PluginEx) {

theModule = ((PluginEx)p).requiredModule( );
if (theModule != null) {

ar.add(theModule);

}

}

}
return ar;

We can assume that these two methods are probably the result of copying and pasting. It is possible that:
1. The classes have a common ancestor. In this case the following refactorings are possible: pull up method, extract superclass.
2. The classes are not connected. In this case, it can be possible to replace these methods with one method in a utility class.
   How this Audit Works

The audit finds similar fragments in:
1. Blocks (fragments inside brackets {}), including whole methods.
2. Complex statements (if, while, for).

The audit results only show fragments that have exactly the same structure. The results do not show fragments that:
1. Differ in one or several statements.
2. Differ in a sequence of identical statements.
3. Are a sequence of statements not limited to a block.

Similar fragments are gathered into clusters. For each cluster, the audit analyzes the differences between fragments.

Results are clusters of duplicated fragments of code, with violations represented as the number of fragments per cluster. For each violation it is possible to view all fragments included in the cluster and a summary fragment with the differences highlighted.

To display a cluster of duplicated fragments, double-click the appropriate line in the table of audit results.

Options

To restrict the size of analyzed fragments, set the parameter Minimal code size (size is calculated as the sum of the number of “;” plus the number of blocks). It is not recommended to set a value less than 5.

Interpreting Results

In most cases, the presence of large identical fragments of code complicates the understanding and maintainability of programs and testifies to design defects in the hierarchy of classes. However, there are exceptions. For example, the absence of template classes in Java results in the occurrence of absolutely identical methods of the various types overloaded for processing. The java.util.Arrays.sort1( ) methods are an excellent example.
1. java.util.Arrays.sort1(byte[] x, int off, int len)
2. java.util.Arrays.sort1(char[] x, int off, int len)
3. java.util.Arrays.sort1(double[] x, int off, int len)
4. java.util.Arrays.sort1(float[] x, int off, int len)
5. java.util.Arrays.sort1(int[] x, int off, int len)
6. java.util.Arrays.sort1(long[] x, int off, int len)
7. java.util.Arrays.sort1(short[] x, int off, int len)

These methods have no differences other than the parameter type.

Reference will now be made in detail to the description of the invention as illustrated in the drawings, FIGS. 1-5, which are screen capture views of graphic user interfaces for the audit results summary table according to the present invention.

The drawings illustrate an implementation of the invention and, together with the description, serve to explain the advantages and principles of the invention. While the invention is described in connection with these drawings, there is no intent to limit it to the embodiment or embodiments disclosed therein. The following description corresponds to the figures and to a particular embodiment as set forth in user instructions and/or a user guide format.

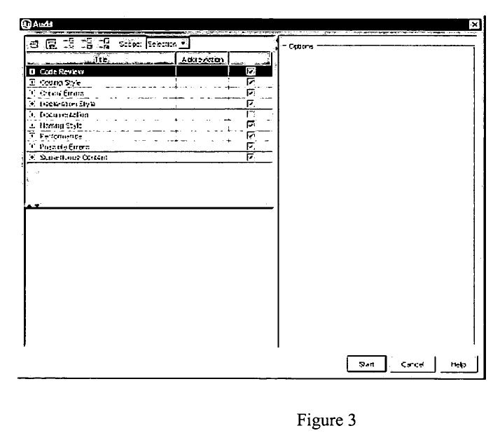

FIG. 1 shows a screen capture of a GUI showing identified similar code fragments according to the present invention. FIG. 2 shows a screen capture of a GUI providing a results table for a user for auditing code according to the present invention. FIG. 1 shows a dialog to start audit on package “java.util” from Java 1.4 sources. Audit performs analyze of all classes in package “java.util” and in it subs packages. The minimal code size fragments is set to 10 statements. The results of this audit are shown on FIG. 2. FIG. 2 shows that methods “java.util.Vector.indexof(Object,int)” and “java.util.ArrayList.indexOf(Object)” have similar body. Differences are highlighted. Methods' classes have common ancestor “AbstractList”. The body of one method is shown in editor pane. FIGS. 3-5 provide GUIs associated with software and methods for automatically providing audits using language grammar driven recognizer of similar code fragments for software development having a language grammar driven recognizer for assessing the similarity of identified source code fragments, wherein the recognizer determines the similarity of the code fragments based upon similarity strategies. The following selections from a user manual associated with the design example illustrating the present invention language grammar driven recognizer of similar code fragments for software development having a language grammar driven recognizer for assessing the similarity of identified source code fragments are provided to further illustrate steps associated with the methods.

Running Quality Assurance
A user can run quality assurance (QA) on a project to check the quality of the code against a set of predefined measurements.

Running Audits
Open the Cash Sales sample project to work with the QA features.

To run audits on the Cash Sales project:
1 Choose Quality Assurance>Audits from the JBuilderX Developer Project menu.
2 The Audits dialog opens as shown in FIG. 3. You can use this dialog to choose the specific audits you want to run. As you select each audit, a description displays in the lower pane of the dialog. For each audit, the severity level (and other audit-specific options) is displayed in the right-hand Options pane of the dialog. Change these settings as necessary.

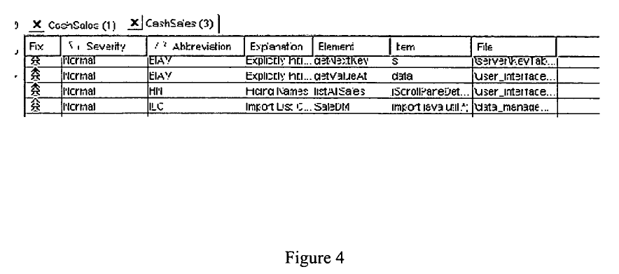

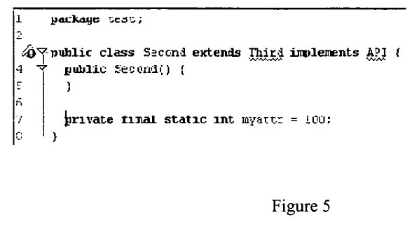

FIG. 3 Audit dialog
3 Accept the default values, and click Start to run the audits. The software automatically generates the results, and displays them in the Audits tab as shown in FIG. 4.
In the Audit results tab, double click the first entry, UPCM. Together opens the source code in the Editor, and highlights the line as shown in FIG. 5.

FIG. 5 Editor showing problematic source code
5 From the Audit results tab, right click the first entry, UPCM, and choose Show
Description. This opens a description of the UPCM audit. Click Close.

Automatically Correcting Audit Violations
Some of the audit rules provide automatic correction for violations. This helps the user quickly fix certain problems when he/she runs audits to check your own code. In the results table, violations that can be automatically corrected are marked with the green traffic light in the Fix column. If automatic correction is prohibited, the violation is marked with the red traffic light:

To Automatically Correct Audit Violations:
1 In the Audit results table, select the first row, UPCM.
2 From the context menu, choose Auto Correct. The Auto Correct dialog opens.
3 Choose the option to correct This violation only.
4 Click Yes.
The Fix column in the Audit results table is updated with a check mark indicating that the audit violation has been fixed. The member is commented out in the source code.

Generating Reports for Audits and Metrics
The user can generate reports for both audit and metric results.

To Generate an HTML Report for your Metric Results:
1 Right click on the table in the Metric results tab, and choose Export|Entire
Table. This opens the Export Results to File dialog.
Tip The user can also limit the scope of the generated report by selecting multiple rows in the Metric results tab, and choosing Export|Selected Rows from the context menu.
2 Click the drop down arrow to the far right of the Type field, and select Generate HTMLfile from the list.
3 Enter a location for saving the report in the File field, or click the File Chooser button.
4 Be sure that the option Launch Viewer is checked, and click OK. Together generates the report, saves it, and opens it in the default browser of your system.

The present invention system and methods provide for groups of code having the same or similar code structure to be capable of being opened in a software editor, processed according to similarity strategies as set forth hereinabove, and shown in an audit results table. Preferably, the audit results table is viewable by the user via a graphic user interface displayed on a computer screen display. Also, preferably, the audit results table includes an indication of a found group power or an amount of common fragments and/or includes an indication of a size of every fragment or an amount of common statements identified by the software and methods.

Preferably, the present invention language grammar driven recognizer of similar code fragments and methods support any language having expression-level parsers. Furthermore, the present invention provides for a visualizer for representing the groups in a graphic user interface viewable by the user, wherein a visual representation of the groups is provided in a form convenient for future in-depth analysis by the user and/or software, such as in a summary review form, wherein the code is normalized, i.e., removing comments and white spaces, and shows the text of every potential code block/group. Preferably, the summary review form is operable to suggest appropriate refactoring of the code considered.

The visualizer further provides or includes a list of methods and a list of highlighted differences within the source code groups or fragments that are compared using the similarity strategies. The list of highlighted differences applies to the duplicate code fragments and/or groups of code.

In a preferred embodiment of the present invention language grammar driven recognizer of similar code fragments and methods, the visual representation of the groups of same or similar code is presented in single-pane view GUI to the user, which provides for convenient comparative information presented simultaneously for decision-making and further analysis as needed by the user.

The present invention also includes methods for providing a language grammar driven recognizer of similar code fragments for software including the steps of providing a data processing system including a processor and a memory device on which a software program is running; the software program providing a pattern and a user interface; at least one input device and an output device for interfacing with a user; the output device including a display and the at least one input device including at least one indication; and a language grammar driven recognizer of similar code fragments, wherein the user selects and inputs the at least one indication into the software; the software program automatically providing language grammar driven recognizer of similar code fragments for software based upon similarity strategies, which may be provided by the user inputs and selections and/or default settings established by the software, such that the software is operable to identify the compared at least two code blocks as being similar although their contents are not identical.

Certain modifications and improvements will occur to those skilled in the art upon a reading of the foregoing description. By way of example, the present invention as set forth hereinabove shows that methods are candidates to the following refactoring: extract superclass, extract method, pull up method, rename and pull up variable. The present invention and this disclosure is intended cover all alternatives, modifications, and equivalents included within the spirit and scope of the invention set forth herein. All modifications and improvements have been deleted herein for the sake of conciseness and readability but are properly within the scope of the following claims.

What is claimed is:

1. A system for providing language grammar driven recognizer of similar code fragments for software development comprising:
a data processing system including a processor and a memory device on which a software program is running; the software program providing a pattern and a user interface; at least one input device and an output device for interfacing with a user; the output device including a display and the at least one input device including at least one indication; and a language grammar driven recognizer for assessing the similarity of identified source code fragments, wherein the recognizer determines the similarity of the code fragments based upon similarity strategies.

2. The system of claim 1, wherein the software is operable to build a textual representation of the source code using terms grammar productions, including terminal and non-terminal symbols.

3. The system of claim 1, wherein the software is operable to replace all occurrences of grammar production with predefined symbols for identifier, literal, operation and code block.

4. The system of claim 1, wherein the software is operable to store the original identifiers and literals in special tables.

5. The system of claim 1, wherein the software automatically provides for stored references to the source code to concrete positions for all signatures.

6. The system of claim 1, wherein the software is operable to search signature list for occurrences of similar or near-same structures.

7. The system of claim 1, wherein the similarity strategy is specified by the user.

8. The system of claim 1, wherein the software is operable to identify at least two code fragments as similar regardless of their contents.

9. The system of claim 1, wherein the software shows results of identified similar code fragments in an audit results table.

10. A method for providing real-time thread simulation for software comprising the steps of: providing a data processing system including a processor and a memory device on which a software program is running; the software program providing a language grammar driven recognizer for assessing the similarity of identified source code fragments and a user interface viewable by a user on the output device; at least one input device and an output device for interfacing with a user; the output device including a display and the at least one input device including at least one indication made by the user; and language grammar driven recognizer for assessing the similarity of identified source code fragments;
the software program operating to automatically assess the similarity of the source code fragments based upon similarity strategies.

11. The method of claim 10, further including the step of building textual representation of the source code in terms grammar productions including terminal and non-terminal symbols.

12. The method of claim 11, wherein all occurrences of grammar productions for identifier, literal, operation and code block are replaced by predefined symbols.

13. The method of claim 10, further including the step of storing original identifiers and literals in special tables.

14. The method of claim 10, further including the step of storing references to the source code to concrete positions for all signatures.

15. The method of claim 10, further including the step of searching a signature list for occurrences of similar or same structures.

16. The method of claim 10, wherein the similarity strategy is specified by the user.

17. The method of claim 10, wherein at least two code blocks are compared automatically.

18. The method of claim 17, wherein the software identifies the code blocks as being similar although their contents are not identical.

19. The method of claim 10, further including the step of the software automatically showing similar code fragments in an audit results table.

20. The method of claim 10, further including the step of the software automatically providing a visual representation of the similar code fragments in a form convenient for future in-depth analysis.
